(19) United States
(12) Patent Application Publication
(10) Pub. No.: US 2005/0107093 A1
(43) Pub. Date: May 19, 2005

(54) Extraneous control of mobile telephone

(75) Inventor: Martin J. Dowling, Plymouth Meeting, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/842,346

(22) Filed: May 10, 2004

Related U.S. Application Data
(60) Provisional application No. 60/519,686, filed on Nov. 13, 2003.

(51) Int. Cl. H04B 1/69; H04B 1/707; H04B 1/713; H04Q 7/20

(52) U.S. Cl. 455/456.4; 455/456.1

(57) ABSTRACT

A wireless transmit/receive unit (WTRU) responds to a predetermined sequence of broadcast signals in order to enter a quiet mode of operation. A reverse sequence provides an indication for returning to a normal mode of operation. The sequence permits control of the WTRU by crossing an entrance threshold or the like, and also allows control by general area broadcast of the sequence.

### CROSS REFERENCE TO RELATED APPLICATIONS

This application claims priority from U.S. Provisional Application No. 60/519,686 filed on Nov. 13, 2003, which is incorporated by reference as if fully set forth.

### FIELD OF INVENTION

The present invention relates to mobile telephony. More particularly, the present invention is directed to control of wireless transmit/receive units (WTRUs) including cellular telephones in accordance with its immediate environment.

### BACKGROUND

As convenient as cellular telephones or wireless transmit/receive units (WTRUs), in general, are in certain places they can be an annoyance and even a hazard. For example, cellular telephones are forbidden in hospitals because they could potentially interfere with patient monitors. Their use on airplanes during takeoff and landing is prohibited because they are presumed to disrupt communication and navigation equipment. Although a lower priority due to annoyance to other people, cellular telephone use is banned in restaurants, theaters, houses of worship, and concerts as a courtesy to other patrons.

In general, users of WTRUs try to comply with these restrictions. If the user remembers, he/she will turn off the WTRU or switch it to a “silent”, such as “vibrate” or “light” mode of annunciating. However, the user may be distracted and forget to turn off or switch the mode of the WTRU. The user may decide to ignore the restriction or be unaware of the restriction, such as by not seeing a sign. Another undesirable result is that after a user turns off the WTRU restricted area, the user may forget to turn the WTRU back on after entering an unrestricted area. As a result, the user may unnecessarily miss an important call.

It is possible to purchase devices which jam cellular signals; however these block all signals within the proscribed frequencies, so that it is impossible for a user of a WTRU to override the control. This prevents various forms of acceptable use of the WTRU, such as for emergencies and use which would not disturb others.

Accordingly, it is desirable to have alternate approaches to control wireless access.

### SUMMARY

In accordance with the present invention, a sequence of signals is used to indicate to a WTRU the presence of a restricted zone. WTRUs, upon receiving the sequence, enter a restricted mode. The reversal of the sequence permits the WTRUs to enter a normal mode. The sequence allows the signals to be configured for a gateway allowing “pass through” reception of the two signals in sequence, as well as sequential broadcast of the signals in which all users in a given area are sequentially signaled.

In accordance with one particular aspect of the invention, the restricted mode sets the WTRU to a user-selected configuration which either shuts off the WTRU or allows it to receive calls in a silent manner, such as by a vibratory ringer

### BRIEF DESCRIPTION OF THE DRAWINGS

FIG. 1 is a diagram showing a configuration in which a threshold barrier is established by a sequence of signals.

FIG. 2 is a diagram showing a configuration in which a local transmitter broadcasts a sequence of signals within a confined area.

FIG. 3 is a diagram showing a configuration in which a local transmitter broadcasts a sequence of signals within a confined area, and a non-designated area is indicated by positioned transmitters.

FIG. 4 is a diagram depicting a WTRU configured to implement the present invention.

FIG. 5 is a flow diagram showing the operation of the present invention.

### DETAILED DESCRIPTION OF THE PREFERRED EMBODIMENTS

Although the features and elements of the present invention are described in the preferred embodiments and to particular combinations, each feature or element can be used alone (without the other features and elements of the preferred embodiments) or in various combinations with or without other features and elements of the present invention. A WTRU includes but is not limited to a user equipment (UE), mobile station, fixed or mobile subscriber unit, pager, or any other type of device capable of operating in a wireless environment. These exemplary types of wireless environments include, but are not limited to, wireless local area networks (WLANs) and public land mobile networks. The term “base station” as used hereinafter includes, but is not limited to, a Node B, site controller, access point or other interfacing device in a wireless environment.

In general, a WTRU is able to receive broadcast messages which meet particular criteria, which are provided as part of wireless transmissions. Such transmissions are for use with voice as well as data using regular and high speed data packet access (HSDPA) transmissions according to the Third Generation Partnership Project (3GPP) wideband code division multiple access (W-CDMA) communication system. The 3GPP system is used only as an example and the invention can be applied to other wireless communication systems. While the exemplary embodiments are described in terms of spread spectrum communications, the invention can be applied to other forms of slotted communications and can be applied broadly to communications in general. While base-to-WTRU transmissions have been described, the inventive concepts are also useful in peer-to-peer communications.

According to the present invention, a WTRU responds to a pair of signals in order to enter a “restricted mode” of operation. If the signals are received in a predetermined forward sequence of a designated first signal followed within predetermined time limits of a predetermined second signal, the restricted mode is invoked. This permits the restricted mode to be initiated by using two different configurations, in accordance with the circumstances. In the exemplary embodiments, the restricted mode is a predetermined mode, such as a predetermined quiet mode.

In one configuration, the sequence can be provided by a pair of fixed transmitters. This configuration provides for implementation when it is desired to keep the controlling signal transmit power extremely low. The restriction applies continuously while the patron is in a building or room, such as for example in a concert or hospital. It works as follows: first, two low power transmitters (A and B) are arranged in series so that an entering person passes A first and B second. Second, the patron's WTRU has a receiver that picks up signal A first and B second. The WTRU is designed so that when it receives signal A first followed shortly by signal B, it enters the restricted mode. This mode for example, disables its ringing circuit and ability to place a call. The WTRU could still vibrate to indicate an incoming call. Third, the restricted mode could be manually overridden at any time. Finally, when the patron leaves, signal B occurs before signal A and the WTRU returns to the normal mode. The A and B transmissions are preferably in the same frequency band, but are distinct, for example by different modulation patterns. By way of simple example, the signals can include: signal A—00111111, and signal B—00000011. Further variations or extensions to the code can provide specific control instructions, such as, “Operation at reduced volume acceptable,” or “Turn WTRU completely off.”

The positioning of the transmitters would be one of design choice. For example, it may be desired to place these at a location where people pass in order to move into or out of an area of concern. The WTRU is set to a receive threshold whereby a predetermined signal strength is required for the WTRU to respond to the fixed transmitters. Since the transmitters are localized, typically, it is not necessary to be extremely precise when setting the receive threshold. The purpose is that the WTRU respond when a signal of a sufficient strength is received, and not respond when outside of the intended area for reception.

In order to prevent inadvertent activation of the restricted mode functions, the signals for entering or leaving the restricted mode are provided with sufficient data to prevent false triggering. This can be either a modulation of the signals themselves or a further signal to reduce ambiguity in the receipt of the signals. Modulation, in addition to reducing false activation of the functions, can be used to control the particular restriction imposed at the location.

In another configuration, the sequence can be provided by a sequential transmission of the two signals within a predefined area. This configuration is useful in cases in which the restriction is temporary. The restriction is able to be lifted such as when a plane has achieved level flight, or during a concert intermission. To establish a restricted mode, the broadcast sequence is initiated, in which the broadcast of an A signal is followed by a B signal. The order of signals is reversed when the restrictions are lifted.

While a predetermined sequence is described, it is further possible to provide predetermined classifications of the signals, such as a classification that permits use of the WTRU but signals the WTRU to disable the audible ringer, and a classification that signals the WTRU to discontinue communications. The WTRU can then be left on so as to respond to the reverse sequence, thereby automatically returning to the normal mode of operation.

Particular restrictions can be such that the WTRU is enabled for some functions, such as non-voice data, but disabled for other functions such as audible ring or voice. In this way, the precise rules of permitted and non-permitted operation of the WTRU can be provided to the user as a default mode without a requirement that the user of the WTRU determine which use is permitted. Examples of functions which could be selectively restricted or not restricted include audible ring, optical signaling by illumination, voice functions, incoming data or text messaging, notification of incoming data messages, outgoing data or text messaging, data communications or predetermined types of data communications, newly established voice communications, newly established data communications, voice or data communications initiated by the user of the WTRU voice or data communications initiated externally by the user of the WTRU, voice or data communications of a particular category such as news, and transmissions meeting predetermined categories determined by the user.

The user may also set the WTRU to respond to the restricted area by activating a predetermined mode of operation. A particular mode of operation would include a voice mail override which allows a caller to “punch through” or otherwise indicate to the user that a request for response is made by the caller and/or that a call from a particular caller was received. It is possible to define an “off” mode as the restricted mode, in which case the WTRU would not turn itself back on in response to the reverse broadcast sequence of signals. It is also possible to define a restricted mode in which only enough functions to permit the WTRU to recognize the reverse sequence of signals is activated. This permits the WTRU to be apparently switched off and switched on when receiving the forward and reverse sequence of signals.

In order to accommodate the ability to restrict operation, the WTRUs in some embodiments responds to the signals. This can be a hardwired feature, but preferably this is in part done by programming. By programming the response, different modes of operation in restricted zones are easy to implement during the lifetime of the WTRU.

The ability of the user to override the disabling settings provides an incentive for limiting the restricted mode signals in a manner that would encourage compliance and acceptance by users. The ability to override the disabling settings is significant in cases in which the reverse sequence of signals is not received at the appropriate time. The signals can further be used automatically to users as to the desired permissibility for WTRU use at the particular time and place. This is particular advantageous in situations where several conditions apply to use of cellular telephones, or where the particular restrictions are not immediately apparent to all users.

It is also possible to provide mandatory restrictions. An example would be at a security checkpoint in instances where it is desired to block all communications or all communications of a particular type, such as voice or incoming messages.

The mode of restricted operation can also be used to control the nature of the operation of the WTRU and allow particular restrictions. This permits the establishment of restricted zones which permit operation of WTRUs but on a subdued basis. For example, the volume or type of ringtone can be changed, and this may be sufficient for the courtesy rules of a particular location without otherwise affecting other functions of the WTRU.

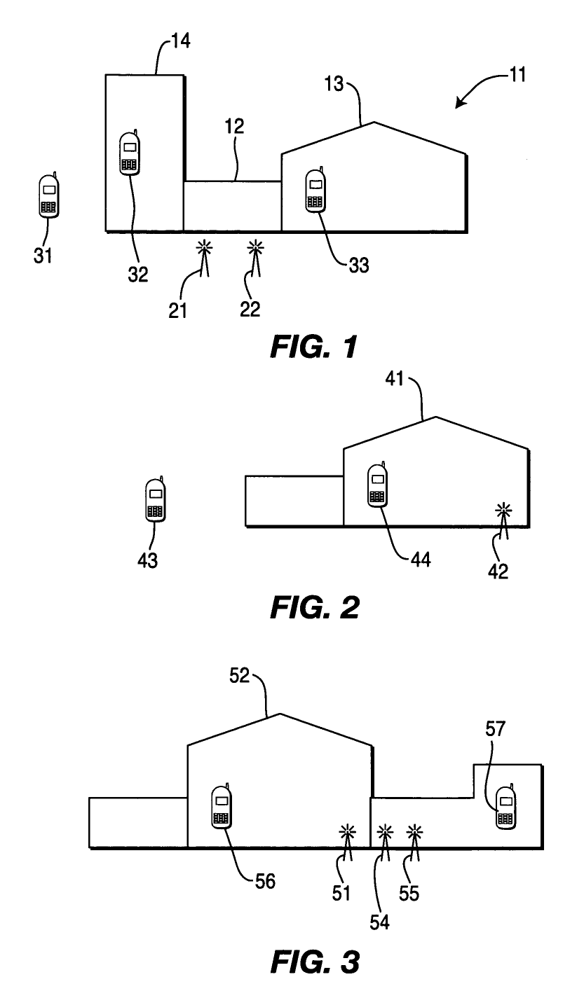

FIG. 1 is a diagram showing a configuration in which a threshold barrier is established by a sequence of signals. A building 11 includes an entranceway 12, and two designated enclosed spaces 13 and 14. One designated enclosed space 13 is deemed to be a “quiet area” in which cellular telephone usage is restricted. A further designated enclosed space 14 is deemed to be not restricted with regard to cellular telephone usage.

A pair of local transmitters 21, 22 are positioned at the entranceway 12, so that people entering the enclosed space 13 pass transmitters 21, 22 in that sequence. The receipt of signals from transmitters 21, 22 in that order by a WTRU indicates entrance into the designated space 13. When the WTRU passes transmitters 21, 22 in a reverse order (22, 21), the WTRU receives the signals from the transmitters in the reverse order, indicating the WTRU is outside of the designated space 13. Thus WTRUs 31 and 32 are outside of the designated enclosed space 13 and WTRU 33 is inside the designated space. Movement of a WTRU from the positions of WTRUs 31 and 32 to the position of WTRU 33 results in the forward sequence of received signals from transmitters 21, 22, so that the WTRU is signaled to go to the quiescent mode. If WTRU 33 is moved to the position of WTRU 31 or 32, it receives the reverse sequence 22, 21 and is signaled to go to the normal mode. The WTRU can optionally be set to notify the user of transition through the restricted area defined by transmitters 21, 22.

The WTRUs 31-33 can be configured to notify the user of entry to or exit from a designated space. This provides the user with an indication of the change of status and also indicates to the user that the change in mode has been effected so that the user does not need to do so manually. In one configuration, the user can override the change in mode, and the notification of entry or exit permits the user to know when the function is activated. In this way, the user can manually override the restriction, or, alternatively, turn off additional functions of the WTRU which the user determines are unneeded.

While enclosed areas are described, it is possible to implement the invention for non-enclosed areas as well, provided that localized broadcasts of the signal sequence may be provided. It is also possible to include a third local transmitter (not shown) to permit activation of functions at a location separate from transmitters 21, 22. This would avoid the problem of users immediately receiving message annunciations when leaving the restricted area at the gateway defined by transmitters 21, 22, and would provide users advanced warning of entry into the restricted area, for example during a conversation.

FIG. 2 is a diagram showing a configuration in which a local transmitter broadcasts a sequence of signals within a confined area. A designated enclosed space 41 is defined by the transmission coverage of a local transmitter 42. A WTRU 43 located outside of the enclosed space 41 operates normally and does not receive signals from the local transmitter 42 at sufficient strength for signal detection from the local transmitter 42. If it is desired to turn off cellphones or turn off cellphone ringers, the local transmitter 42 transmits a sequence of signals corresponding to the sequence of entering the building in FIG. 1, past transmitters 21, 22. This would affect a WTRU 44 inside the designated space 41 but not the WTRU 43 outside the designated space. The reverse sequence of transmissions by local transmitter 42 signals the WTRU 43 to go to the normal mode.

FIG. 3 is a diagram showing a configuration in which a local transmitter 51 broadcasts a sequence of signals within a confined area 52, and a non-designated area is indicated by positioned transmitters 54, 55. A WTRU 56 in the area 52 served by the local transmitter 51 responds according to a sequence of signals provided by transmitter 51. If transmitter 51 signals WTRU 56 to go to a quiet mode, it remains possible for the user of WTRU 56 to leave the confined area 52, as represented by WTRU 57. In that case, transmitters 54, 55 transmit a sequence which signals the WTRU to switch to normal mode upon leaving the confined area 52, and when entering the confined area 52, the signals from the transmitters 54, 55 are in the reverse sequence. Thus the user is electronically switched to a normal mode when leaving the confined area 52 and automatically switched back to quiet mode when returning.

This arrangement is advantageous in situations where it is not absolutely clear where cellular telephone use is unrestricted, and also makes it convenient to switch the WTRU between quiet and normal modes. This further has the advantage of encouraging cellphone users to accept the quiet restrictions because the users know that the WTRU is signaled to switch to normal mode when leaving the restricted area.

In most cases when the confined area 52 is switched to a non-restricted mode, such as after an event or the like, transmitter 51 can signal the change to normal mode and transmitters 54, 55 can be turned off. Thus, someone who left the restricted area is not signaled to switch back to the restricted mode when the confined area 52 is not subject to a request for quiet mode.

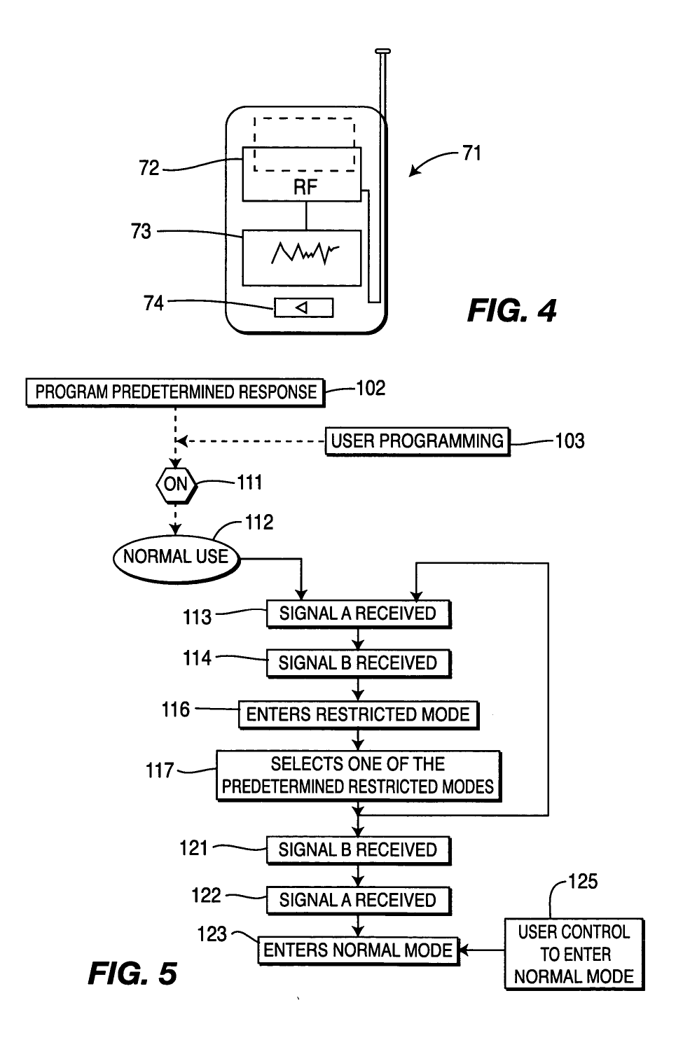

FIG. 4 is a diagram depicting a WTRU 71. The components of FIG. 4 may be implemented as a single or multiple integrated circuits, as discrete components or a combination of discrete components and integrated circuits. The WTRU 71 includes an RF section or module 72, a processing circuit section or module 73 and an audio circuit section or module 74. The modules 72-74, while shown separately, may be integrated as a single unit. The RF module 72 enables the WTRU to transmit and receive through a wireless network, but also permits reception of signals from the local transmitters 21-22, 42, 51 and 54-55 (FIGS. 1-3). When the WTRU 71 receives a signal from a local transmitter, the RF circuit module 72 receives the signal, which is processed by the processing module 73 in order to provide the desired control of the WTRU 71. The processing module 73 is preferably able to be programmed which allows the programming of a desired response to the sequence of signals, user control or acceptance of the response to the sequence of signals, and establishment of different modes of operation in response to the sequence of signals.

FIG. 5 is a flow diagram showing the operation of the present invention. The WTRU is programmed for a predetermined response (step 102) either upon manufacture or via a programming update. This provides that the WTRU enter a predetermined quiet mode of operation, enter a predetermined mode defined by the user, turn off or otherwise respond to the sequence of signals. The user also is able to program (step 103) a desired response to the sequence. In use, the WTRU is turned on (step 111) and placed in a normal use mode (step 112). Upon receipt (steps 113, 114) of a first sequence of signals A and B, the WTRU enters a restricted mode (step 116). The WTRU selects one of a plurality of predetermined restricted modes (step 117) in accordance with modulations of the signals A and B. The sequence of entering the restricted mode (step 116) and selecting a predetermined restricted mode (step 117) can be repeated if the particular circumstances warrant changing the mode of operation, for example from “subdued” to “quiet” or vice versa. If the WTRU is able to receive the reverse sequence of signals (steps 121, 122), the WTRU responds by entering a normal mode (step 123). The user can also program the WTRU to enter the quiet mode or to enter the normal mode (step 125).

The type of signal transmitted would be a matter of design choice, and would be chosen for simplicity of design and adaptability to any regional variations in cellular telephone standards. If possible, the signal would be selected so that existing WTRUs can be programmed to respond to the signals as desired. In countries with monolithic standards, the selection would be simplified; however, it is possible to simultaneously broadcast signals adaptable to different standards. It is also possible to use the local transmitters 21-22, 42, 51 and 54-55 (FIGS. 1-3) for other functions related to the operation of the WTRUs, such as “hot spot” operation.

In a further embodiment, the WTRU can be permitted to signal the user of previously received messages upon leaving a restricted area. This can be accomplished by simply providing the annunciation associated with the particular type of message. Alternatively, the WTRU can respond to leaving the restricted area by displaying missed message notifications automatically. Since the user is generally aware of leaving the restricted area, the user is likely to look at the WTRU at that time, which would make automatic display of the missed message notifications convenient.

1. A wireless transmit/receive unit (WTRU) programmed to respond to a disabling signal, the WTRU comprising:
a receiver circuit capable of receiving signals of predetermined characteristics; and
the receiver configured so that, on receipt of the signals of the predetermined characteristics, the receiver enters a predetermined quiet mode of operation.

2. The WTRU of claim 1, wherein the signals of predetermined characteristics including a predetermined sequence of signals corresponding to at least two distinct transmissions, such that the receipt of the signals in the predetermined sequence provides an indication of an environment for the predetermined quiet mode of operation.

3. The WTRU of claim 1, wherein the signals of predetermined characteristics including a predetermined sequence of signals, such that the receipt of the signals in the predetermined sequence provides an indication of an environment for the predetermined quiet mode of operation.

4. The WTRU of claim 3, wherein a reverse sequence provides an indication of termination of an environment for the predetermined quiet mode of operation.

5. The WTRU of claim 3, wherein the WTRU responding to the received signals by entering one of a plurality of predetermined quiet modes of operation, the predetermined quiet mode of operation selected in accordance with at least one of the received signals.

6. The WTRU of claim 1, wherein the predetermined quiet mode established in accordance with a programmed selection of the modes of operation.

7. The WTRU of claim 1, wherein the WTRU providing an indication to the user of crossing a threshold of an area of implementation of the predetermined mode of operation.

8. The WTRU of claim 1, comprising an override function, whereby the user may override the predetermined quiet mode of operation.

9. A method of providing operating control for wireless transmit/receive units (WTRUs), the method comprising:
providing signals of predetermined characteristics for receipt by WTRUs in a first predetermined sequence, whereby the signals in the first predetermined sequence of the signals provide an indication for the WTRUs to enter a predetermined mode of operation; and
providing signals of the predetermined characteristics for receipt by WTRUs in a second sequence, whereby the signals provided in the second predetermined sequence provide an indication for the WTRUs to terminate the predetermined mode of operation.

10. The method of claim 9, comprising providing the second predetermined sequence of operation as at least a partial reverse order of the first predetermined mode of operation, thereby providing an ability to control the WTRUs according to movement across a predetermined threshold location.

11. The method of claim 10, comprising providing the signals at the threshold when using movement across the threshold as a criterion, and providing the signals in a general area when using a combination of time and location as criteria.

12. The method of claim 10, comprising providing at least one additional signal, thereby providing a plurality of predetermined quiet modes of operation in accordance with the received signals.

13. The method of claim 9, wherein the signals of predetermined characteristics including a predetermined sequence of signals corresponding to at least two distinct transmissions, such that the receipt of the signals in the predetermined sequence provides an indication of an environment for the predetermined quiet mode of operation.

14. The method of claim 9, wherein the signals of predetermined characteristics including a predetermined sequence of signals corresponding to at least two distinct transmissions from transmission locations defining a directional threshold crossing, such that the receipt of the signals in the predetermined sequence provides an indication of an environment for the predetermined quiet mode of operation, the second predetermined sequence of operation provided as at least a partial reverse order of the first predetermined mode of operation, thereby providing an ability to control the WTRUs according to movement across the threshold crossing.

15. The method of claim 9, wherein the WTRU responding to the received signals by entering one of a plurality of predetermined quiet modes of operation, the one predetermined quiet mode of operation selected in accordance with at least one of the received signals.

16. The method of claim 9, wherein the predetermined mode established in accordance with a programmed selection of the modes of operation.

17. The method of claim 9, comprising using the WTRU to provide an indication to the user of crossing a threshold of an area of implementation of the predetermined mode of operation.

18. The method of claim 9, comprising providing an override function, whereby the user may override the predetermined quiet mode of operation.

19. A program product for use in controlling the operation of a wireless transmit/receive unit (WTRU), the program product comprising:
code to recognize receipt of signals of predetermined characteristics designated for external control of an operating mode of the WTRU; and
code to control the receiver so that, on receipt of the signals of the predetermined characteristics, the receiver enters a predetermined quiet mode of operation in accordance with the programming.

20. The program product of claim 19, wherein:
the code to recognize receipt of the signals responsive to signals provided for receipt by the WTRU in a first predetermined sequence, whereby the signals in the first predetermined sequence of the signals provide an indication for the WTRU to enter a predetermined mode of operation; and
the code to recognize receipt of the signals responsive to signals provided for receipt by the WTRU in a second sequence, whereby the signals provided in the second predetermined sequence provide an indication for the WTRU to terminate the predetermined mode of operation.

21. The program product of claim 20, wherein the second predetermined sequence provided as a reverse order of the first predetermined mode of operation, thereby providing an ability to control the WTRUs according to movement across a predetermined threshold location.

22. The program product of claim 20, wherein the response to the first and second predetermined sequence providing control response to movement across a threshold wherein the program product controls the WTRU at the threshold when using movement across the threshold as a criterion, and the response to the first and second predetermined sequence providing control response to a combination of time and location used as criteria.

23. The program product of claim 19, comprising code to respond to at least one additional signal, thereby providing a plurality of predetermined quiet modes of operation in accordance with the received signals.

24. The program product of claim 19, wherein the second predetermined sequence of operation manifested as at least a partial reverse order of the first predetermined mode of operation, thereby providing an ability to control the WTRUs according to movement across a predetermined threshold location.

25. The program product of claim 19, comprising a routine to cause the WTRU to respond to the received signals by entering one of a plurality of predetermined modes of operation, the predetermined quiet mode of operation selected in accordance with at least one of the received signals.

26. The program product of claim 19, further characterized by a routine to provide an indication to the user of crossing a threshold of an area of implementation of the predetermined mode of operation.

27. The program product of claim 19, comprising an override function, whereby the user may override the predetermined quiet mode of operation.
